(19) United States
(12) Patent Application Publication
(10) Pub. No.: US 2025/0215948 A1
(43) Pub. Date: Jul. 3, 2025

(54) ANNULAR CANTILEVER BEAM SPRING AND PRE-LOADED ASSEMBLY

(71) Applicant: Raytheon Company, Tewksbury, MA (US)

(72) Inventors: Gary J. Sutton, Oro Valley, AZ (US); Christipher P. Owan, Tucson, AZ (US); Nicholas R. Leslie, Tucson, AZ (US)

(21) Appl. No.: 18/441,774

(22) Filed: Feb. 14, 2024

Related U.S. Application Data
(60) Provisional application No. 63/615,150, filed on Dec. 27, 2023.

(51) Int. Cl. F16F 1/34

(52) U.S. Cl. CPC F16F 1/34; F16F 2236/085

(57) ABSTRACT

An annular cantilever beam spring is capable of exhibiting low friction and hysteresis and stiffness and specifically stiffness/volume far exceeding currently available COTS springs. The spring includes first and second sets of N stand-offs evenly positioned around opposing top and bottom surfaces of a flat annular beam at 360/N degree intervals and angularly offset with respect to each other by 360/2N degrees such that each said stand-off is evenly spaced between adjacent pairs of stand-offs on the opposing surface. The first and second sets of stand-offs are responsive to opposing axial loads to deflect the flat annular beam axially at each stand-off in opposing directions to induce a curvature to the annular beam and store energy in the beam. The spring stiffness is determined by the elastic material properties of the flat annular beam, not the initial geometry as is common with the COTS springs.

### CROSS-REFERENCE TO RELATED APPLICATIONS

This application claims benefit of priority under 35 U.S.C. 119 (e) to U.S. Provisional Application No. 63/615,150 entitled “ANNULAR CANTILEVER BEAM SPRING AND PRE-LOADED ASSEMBLY” and filed on Dec. 27, 2023, the entire contents of which are incorporated by reference.

### BACKGROUND

### Field

This disclosure relates to a spring and pre-loaded assembly to facilitate precise control over the operating geometry of the assembly's mating parts.

### Description of the Related Art

A pre-loaded assembly is one in which compressive forces are applied to remove any “slack” in the assembly, ensure proper alignment and to place the assembly in an operating range in which the assembly either does not respond to external forces or responds to those forces in a known manner. Pre-loading should minimize any friction and resulting hysteresis (latency) or lost motion from the assembly.

Referring now to FIG. 1, a simple pre-loaded system 100 includes first and second mating parts 102 and 104, respectively, positioned about an axis 106 in opposition to each other within a housing 108. A spring 110 is positioned in-line with and either internal (as shown) or external to the first and second mating parts 102 and 104. A pre-load mechanism 110 such as a threaded nut or clamp applies an axial load 112 to the mating parts and the spring to compress and pre-load the assembly to remove any slack and place the assembly in its operating range. Compression of the spring may also serve to minimize any radial or axial misalignment 114 between the mating parts.

Referring now to FIGS. 2A-2G, a variety of commercial off-the-shelf (COTS) springs are available and may be used to pre-load similar assemblies. The selection of the appropriate spring depends on such as factors as required deflection range to take up the slack, spring rate or stiffness, spring size in inner diameter (ID), outer diameter (OD) and thickness, which together define the spring volume, allowable friction and hysteresis, linearity over the deflection range, cost, etc.

As shown in FIG. 2A, a coil spring 200 is formed by winding a wire around a cylinder. Its stiffness properties are largely determined by its geometry including the number and radius of the turns. To provide high stiffness, a coil spring typically requires many turns and thus will be thick and exhibit a low stiffness/volume. As shown in FIGS. 2B-2C, a wave spring 202 is a flat-wire compression spring, which may have a single layer as shown in wave spring 202 or in a stack as shown in wave spring 204. Wave springs typically exhibit low stiffness in order to accommodate a wide deflection range. As shown in FIG. 2D, a Belleville washer 206, also known as a coned-disc spring, conical spring washer, disc spring, Belleville spring or cupped spring washer, is a conical shell which can be loaded along its axis either statically or dynamically. A Belleville washer is a type of spring shaped like a washer. It is the shape, a cone frustrum, that gives the washer its characteristic spring. They may be used to apply a flexible pre-load to a bolted joint or bearing. In a spring-stack, disc springs can be stacked in the same or in an alternating orientation and of course it is possible to stack packets of multiple springs stacked in the same direction. Belleville washers can exhibit high stiffness but due to the geometry have a low stiffness/volume. As shown in FIG. 2E, a slotted-disc spring 208 is similar to a Belleville washer 206 except slots are cut into the shell to provide for repeatable force travel that can used either in a dynamic or static application. Taken together COTS springs exhibit a low spring rate (stiffness)/volume and produce friction that results in hysteresis of the assembly. The spring properties are determined primarily by the geometry of the particular COTS spring and secondarily by the elastic material properties of the spring. In all cases, compression tends to flatten the spring geometry.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

The present disclosure provides a spring capable of exhibiting low friction due to minimal movement at contact points in both the axial and radial directions when force is exerted and low hysteresis and stiffness and specifically stiffness/volume far exceeding currently available COTS springs.

An annular cantilever beam spring includes a flat annular beam having opposing top and bottom surfaces about an axis. A first set of N stand-offs where N is an integer of 3 or more are evenly spaced at 360/N degree intervals about the top surface. A second set of N stand-offs are evenly spaced at 360/N degree intervals about the bottom surface. The first and second sets of stand-offs are angularly offset from each other by 360/2N degrees such that each stand-off is evenly spaced between adjacent pairs of stand-offs on the opposing surface. The first and second sets of stand-offs responsive to opposing axial loads to deflect the flat annular beam axially at each stand-off in opposing directions to induce a curvature to the annular beam and store energy in the beam.

The spring stiffness is determined by the elastic material properties of the flat annular beam, not the initial geometry as is common with the COTS springs. This serves to provide the much higher stiffness/spring volume. As the spring is pre-loaded to induce curvature in flat annular beam, the radius contracts. This contraction is real but negligible producing negligible friction and thus hysteresis. Furthermore, the opposing axial loads are only applied to the stand-offs, the flat annular beam itself is not directly loaded. This reduces the contact area, hence friction, and maintains a linear spring response.

In general, each stand-off may include one or more closely-spaced protrusions. In certain embodiments, each stand-off includes a single protrusion. In a preferred embodiment, N=3, and the stand-offs are evenly spaced at 120 degrees around the flat annular beam and the first and second sets are rotated by 60 degrees with respect to each other.

In different embodiments, the spring may be formed of conventional spring materials such as aluminum or titanium or the same material as an assembly in which the spring is used such as 440C stainless steel, 52100 chrome steel or ceramics.

In an embodiment, the spring is positioned in-line with and internal or external to first and second mating parts. A pre-load mechanism is configured to apply the opposing axial loads to compress the spring and apply a preload within a specified operating range of the assembly. The mating parts or pre-load mechanism only contact the stand-offs to apply the pre-load. The assembly may, for example, include a single bearing, dual-bearings or the friction plate for a spring clutch. Proper selection of the spring materials may provide an assembly that is athermal (thermally stable).

These and other features and advantages of the disclosure will be apparent to those skilled in the art from the following detailed description of preferred embodiments, taken together with the accompanying drawings, in which:

### BRIEF DESCRIPTION OF THE DRAWINGS

FIG. 1, as described above, is a view of a pre-loaded assembly;

FIGS. 2A-2E are views of different COTS springs;

FIGS. 3A-3B are views of an annular cantilever beam spring;

FIGS. 4A-4B are views of an annular cantilever beam spring in which opposing axial loads have been applied to deflect the flat annular beam axially in opposing directions to induce a curvature into the annular beam and store energy in the beam;

FIGS. 5A-5B are views of alternative embodiments of the annular cantilever beam spring in which each stand-off includes two or three protrusions;

FIGS. 6A-6B is a view of a dual-bearing assembly before and after pre-load;

FIGS. 7A-7B are plots of spring deflection vs. preload and spring rate/volume for various COTS springs and the annular cantilever beam spring;

FIG. 8 is an assembled view of a pre-loaded bearing;

FIG. 9 is a view of a friction clutch; and

FIG. 10 is a view of a vibration damper.

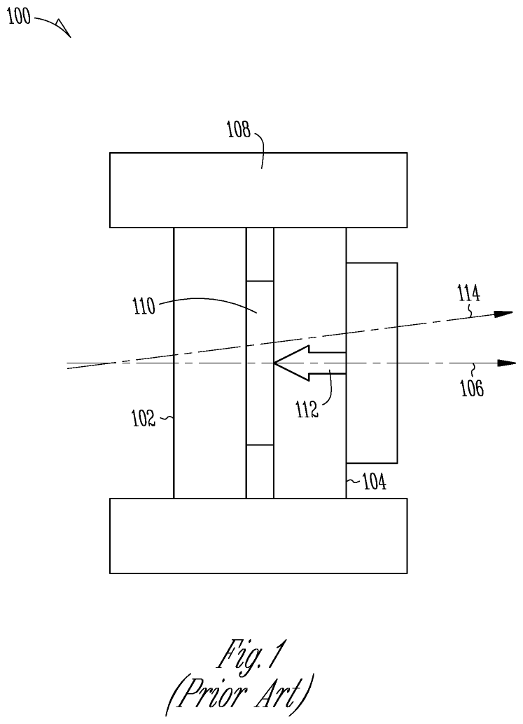

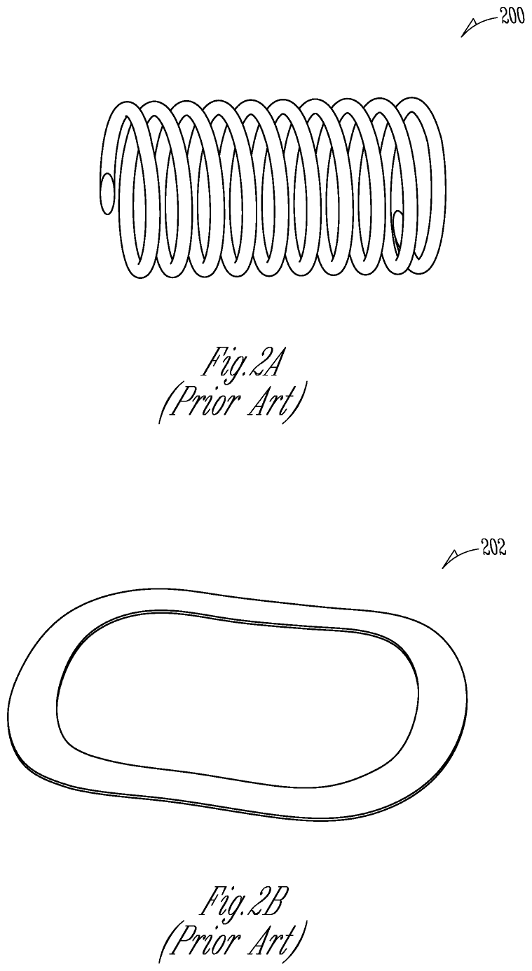

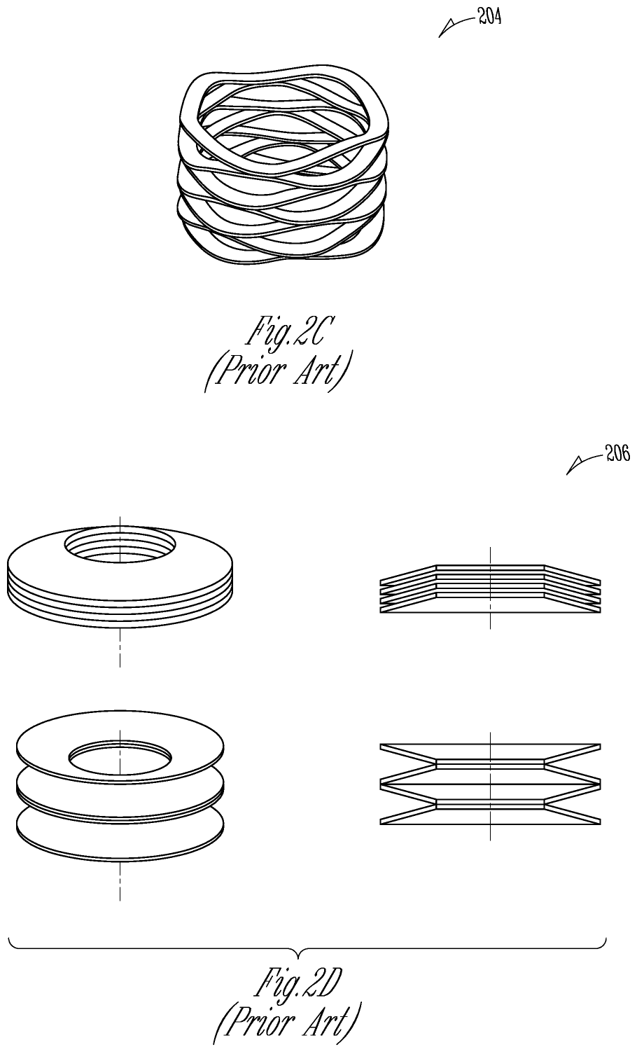

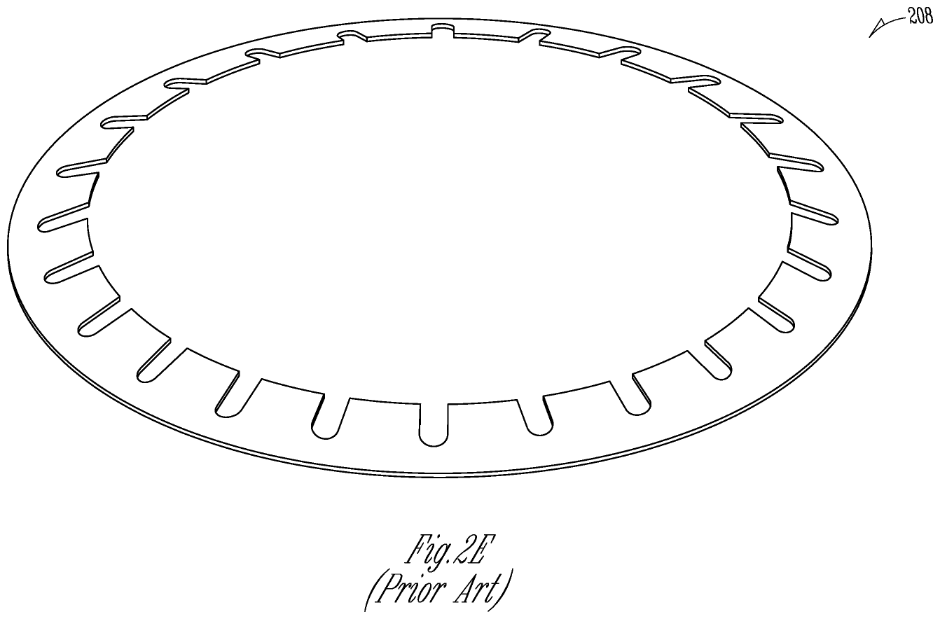

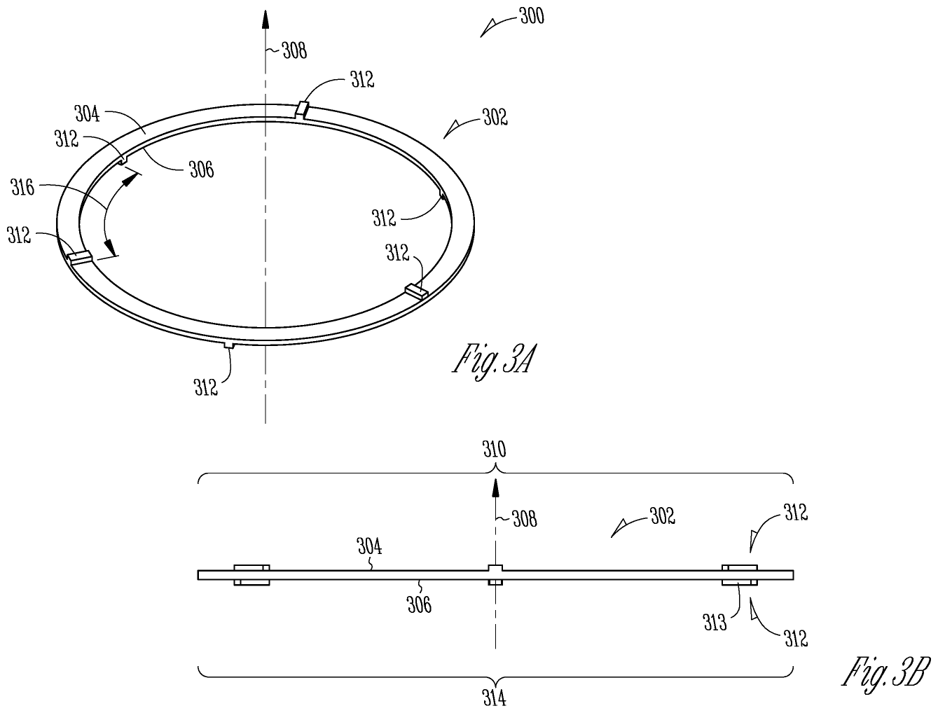

### DETAILED DESCRIPTION

The present disclosure provides a spring capable of exhibiting low friction due to minimal movement at contact points in both the axial and radial directions when force is exerted and low hysteresis and stiffness and specifically stiffness/volume far exceeding currently available COTS springs. The spring stiffness is determined by the elastic material properties of the spring, not the initial geometry as is common with the COTS springs. This serves to provide the much higher stiffness/spring volume. Unlike COTS springs, compression induces a curvature into the spring to store energy.

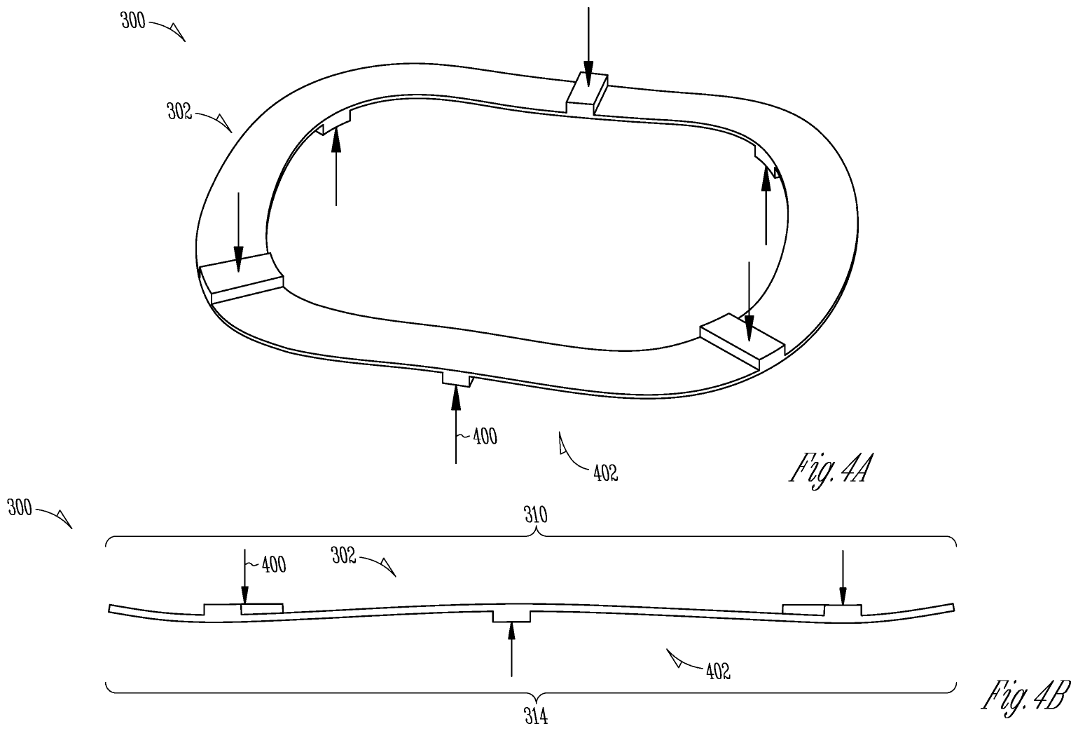

Referring now to FIGS. 3A-3B, an annular cantilever beam spring 300 includes a flat annular beam 302 having opposing top and bottom surfaces 304 and 306, respectively, about an axis 308. A first set 310 of N stand-offs 312 where N is an integer of 3 or more extends from and is evenly spaced at 360/N degree intervals about the top surface 304. A second set 314 of N stand-offs 312 extends from and is evenly spaced at 360/N degree intervals about the bottom surface 306. Each stand-off 312 is made up of one or more protrusions 313 that are closely spaced at the corresponding angular interval. The first and second sets 310 and 314 of stand-offs 312 are angularly offset from each other by an offset 316 of 360/2N degrees such that each said stand-off 312 is evenly spaced between adjacent pairs of stand-offs 312 on the opposing surface. Although N may be any integer greater than 3 a top end of the range is practically 8, which corresponds to an angular spacing of every 45 degrees. N=3 is a preferable number as 3 stand-offs establish a plane. More than 3 stand-offs contacting simultaneously, which will introduce a secondary contact event. At N=3, the stand-offs on each side are spaced at 120 degrees and the angular offset is 60 degrees.

The spring stiffness is determined by the elastic properties of the material itself as well as the ID, OD and thickness of the flat annular beam 302. The spring material may be selected to match the mating parts in any assembly such as 440C stainless steel, 52100 chrome steel or a ceramic. Alternately, the spring material may be a common spring material such as aluminum or titanium. The maximum deflection is determined by the height of the stand-offs 312.

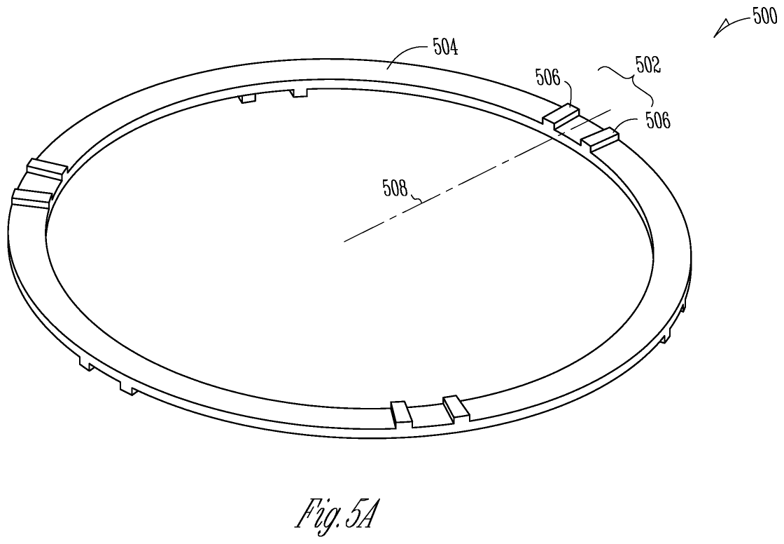

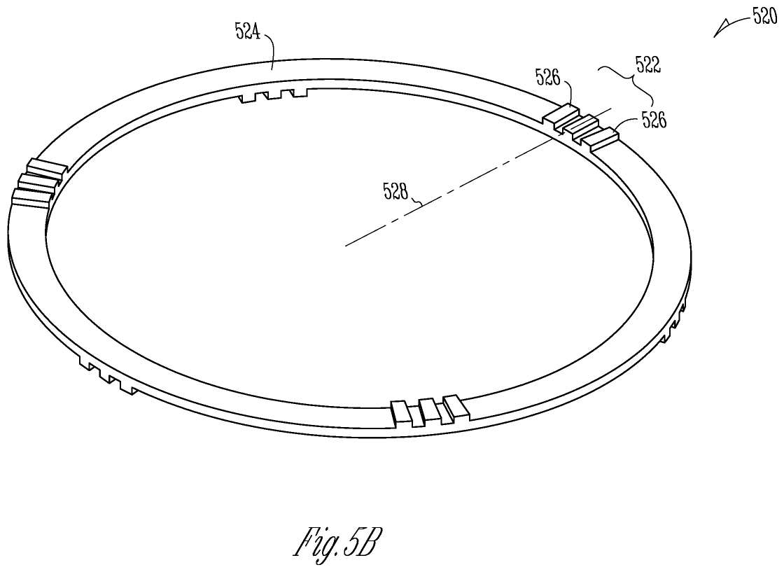

Referring now to FIGS. 4A-4B, the first and second sets 310 and 314, respectively of stand-offs 312 are responsive to opposing axial loads 400 to deflect the flat annular beam 302 axially at each stand-off 312 in opposing directions to induce a curvature 402 to the flat annular beam 302 and store energy in the beam.

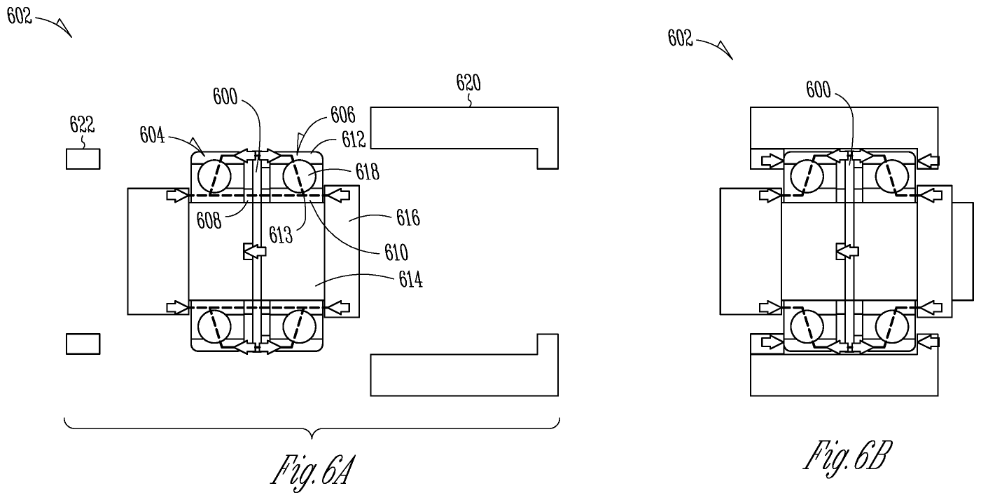

Referring now to FIGS. 5A-5B, in these embodiments the stand-offs include multiple protrusions closely spaced at the corresponding angular interval. A annular cantilever beam spring 500 includes N=3 stand-offs 502 evenly spaced at 120 degree intervals on opposing sides of a flat annular beam 504. Each stand-off 502 includes two protrusions 506 equally and closely spaced from an angular interval 508. A annular cantilever beam spring 520 includes N=3 stand-offs 522 evenly spaced at 120 degree intervals on opposing sides of a flat annular beam 524. Each stand-off 522 includes three protrusions 526 equally and closely spaced about an angular interval 528.

The annular beam spring can be used to pre-load an assembly to remove any “slack” in the assembly, ensure proper alignment and to place the assembly in an operating range in which the assembly either does not respond to external forces or responds to those forces in a known manner. Pre-loading with the annular beam spring minimizes any friction and resulting hysteresis (latency) or lost motion from the assembly. Friction is negligible due to minimal movement at contact points in both the axial and radial directions when force is exerted. Furthermore, because the annular beam spring exhibits high spring rate (stiffness)/volume, the spring itself occupies minimal space.

A pre-loaded assembly includes first and second mating parts positioned along an axis and an annular cantilever beam spring positioned about the axis in-line with and internal or external to the first and second mating parts. A pre-load mechanism is configured to apply opposing axial loads to the first and second mating parts and the stand-offs on the opposing surfaces of the flat annular beam to deflect the flat annular beam axially at each stand-off in opposing directions to induce a curvature to the annular beam and store energy in the beam to preload the assembly. Proper selection of the spring materials may provide an assembly that is athermal (thermally stable).

The spring stiffness is determined by the elastic material properties of the flat annular beam, not the initial geometry as is common with the COTS springs. This serves to provide the much higher stiffness/spring volume. As the spring is pre-loaded to induce curvature in flat annular beam, the radius contracts. This contraction is real but negligible producing negligible friction and thus hysteresis. Furthermore, the opposing axial loads are only applied to the stand-offs, the flat annular beam itself is not directly loaded. This reduces the contact area, hence friction, and maintains a linear spring response. The spring is preferably designed for a given application to provide sufficient deflection clearance under the applied pre-load such that the beam does not “bottom out” in order to preserve a linear spring response.

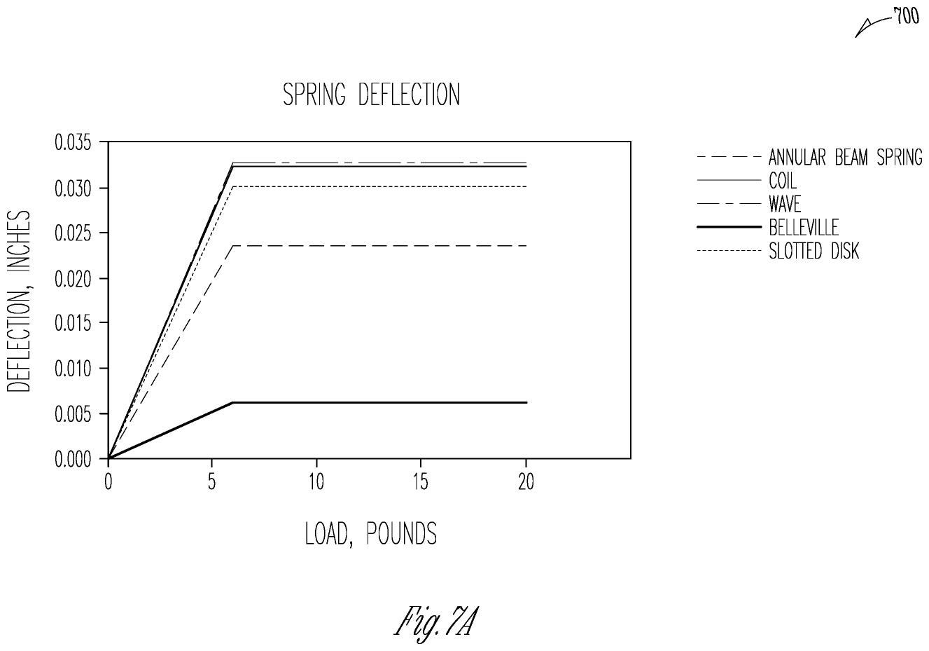

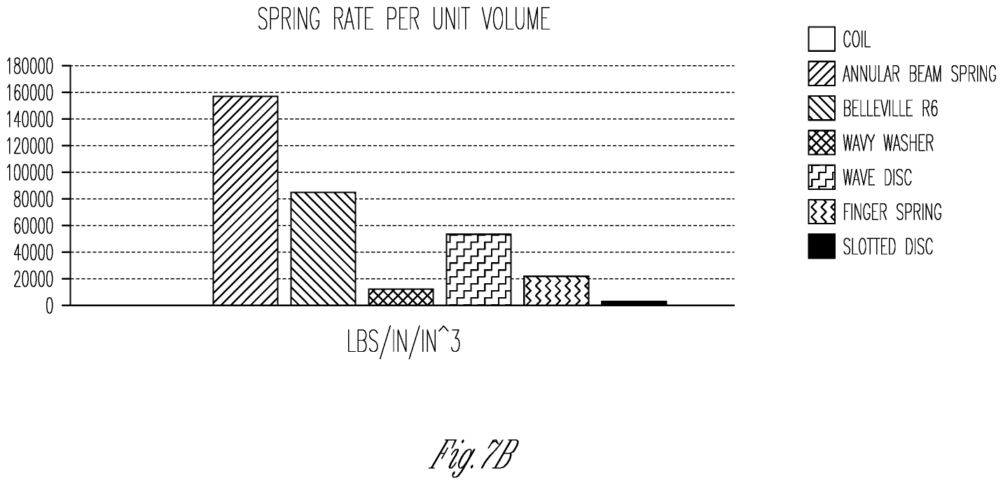

Referring now to FIGS. 6A-6B, in an embodiment an annular beam spring 600 is employed to pre-load a dual-bearing assembly 602, in particular a DB mounting-internal spring mount configuration. In a DB mounting the contact angles diverge at the axis of rotation. DB is used when high bending stiffness of the shaft or rotating members is required and the load is applied outside of the mounted bearings such as in a cantilever type load. The annular beam spring may also be used with a DB mounting with external spring mount or a DF mounting with an internal or external spring mount.

Dual-bearing assembly 602 includes first and second bearings 604 and 606, respectively, having axial facing front and back surfaces. A spacer 608 (e.g., a shim or sleeve) and the annular beam spring 600 are positioned between the bearings' axial facing back surfaces opposite the inner and outer races 610 and 612, respectively. This assembly is installed on a shaft 614 that creates an axis of rotation and clamped via a pre-load mechanism 616. The bearings make solid contact at the inner races 610 during installation. The spring 600 is compressed to induce curvature in the flat annular beam to its working height between the outer races 612 to generate load paths 613 from the inner race 610, through a rolling element 618 (e.g. a ball), the outer race 612, the spring 600, the opposing outer race 612, rolling element 618 and the inner race 610. A housing 620 is placed over the bearings, and the spring and bearings' outer races 612 are clamped in place between housing 620 and stop 622. Spacer 608 provides a path for the load to transfer from the inner to the outer race and back through the inner race. The spacer must be thinner than the spring but thick enough so that the desired deflection at pre-load is met. If the spacer is not properly sized, the spring will not engage and the outer f=races will be free to float.

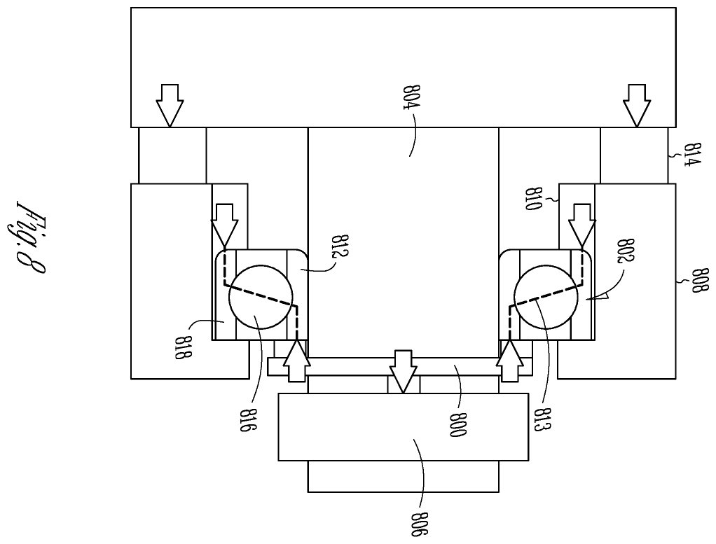

Referring now to FIGS. 7A-7B, plots for spring deflection vs load 700 and spring rate (stiffness) per unit volume 702 are presented for various COTS springs and the annular beam spring. With the exception of the Belleville washer, the springs are sized to match the outer race, and more particularly the landing area, of the outer race on the springs. The conic shape of the Belleville washer is simply not amenable to engage the same race, inner or outer, on a pair of bearings. As shown, COTS coil, wave and slotted disk springs exhibit greater deflection (are less stiff) than the annular beam spring, and most particular exhibit a much lower spring rate per unit volume than the annular beam spring. The Belleville washer is stiffer and has a spring rate per unit volume closer to the annular beam spring but again cannot be used where the spring must have the same diameter on both sides to match equal size bearings, or more generically, equal sized mating parts.

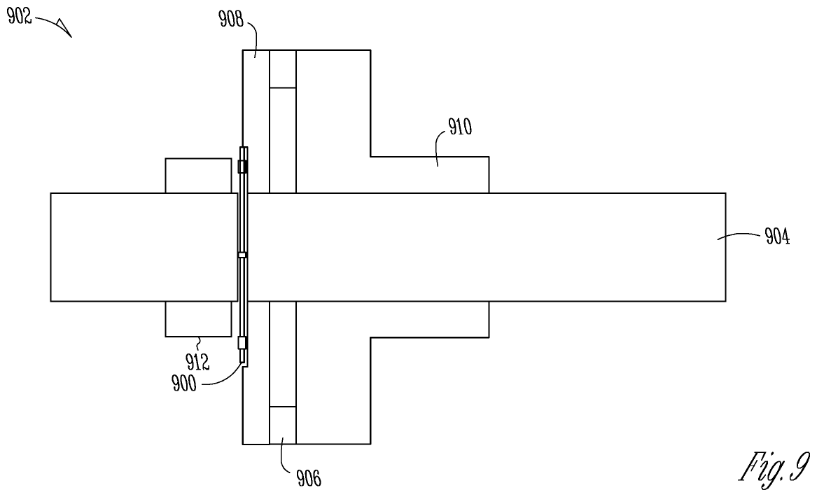

Referring now to FIG. 8, in an embodiment an annular beam spring 800 is employed to pre-load a single roller bearing 802. Spring 800 and bearing 802 are installed on a shaft 804 that creates an axis of rotation and clamped via a pre-load mechanism 806. A housing 808 and a stop 810 is placed over the bearing, and the spring and bearing's outer race 816 are clamped in place between housing 808 and stop 810. In this particular embodiment, a thrust bearing 814 is positioned between the housing 808 and shaft 804. The spring 800 is compressed to induce curvature in the flat annular beam to its working height between the pre-load mechanism 806 and inner race 812 to generate load paths 813 from the inner race 812, through a rolling element 816 (e.g., a ball), and the bearing's outer race 818. Alternately, the stop 810 could be positioned to constrain inner race 812 and the spring positioned opposite outer race 816.

Referring now to FIG. 9, in an embodiment an annular beam spring 900 is employed to pre-load a spring clutch 902 to prevent damage or break from excessive torque. Spring clutch 902 is mounted around a rotating shaft 904. Spring clutch 902 includes a friction disc 906 positioned between a friction plate 908 and an axial-fixed member 910. Annular beam spring 900 is positioned between friction plate 908 and a stop 912. The torque is transmitted through member 910 (gear/pulley/sprocket, etc.) through the friction disc 906, friction plate 908, spring 902 and stop 912, which is fixed axially and radially to 904. Once the torque exceeds the frictional torque between friction disc 906 and member 910, rotation stops. If member 910 is being driven by shaft 904, the instance the frictional force between friction disc 906 and member 910 is exceeded, member 910 stops rotating. When annular beam spring 900 is preloaded, it exerts a force to stop 912 and friction plate 908. The force is acting at a radius defined by the distance between the axis of rotation and the center of the stand-offs. The resulting force F acting at the radius, R, produces a Torque (T=FxR). When this torque is exceeded, the frictional force between friction disc 906 and member 910 is exceeded allowing member 910 to slip.

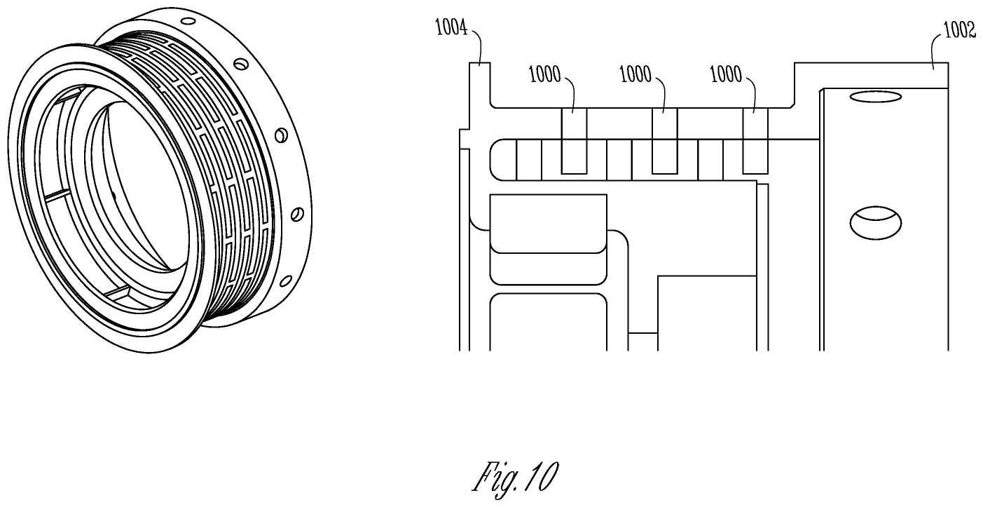

Referring now to FIG. 10, in an embodiment a plurality of annular beam springs 1000 are employed a shock absorber/vibration damper 1002. A series of springs 1000 are assembled and in contact but not preloaded with each other between a fixed member 1002 and a contacting floating member 1004. Floating member 1004 (e.g., a plunger) absorbs an impact from an external source. This impact travels through the series of springs 1000 resulting in their deflection. Upon the release of the impact, the springs return to their unloaded state. The number of springs is determined by the maximum impact force and the material properties of the spring.

While several illustrative embodiments of the disclosure have been shown and described, numerous variations and alternate embodiments will occur to those skilled in the art. Such variations and alternate embodiments are contemplated, and can be made without departing from the spirit and scope of the disclosure as defined in the appended claims.

We claim:

1. An annular cantilever beam spring, comprising:
a flat annular beam having opposing top and bottom surfaces about an axis;
a first set of N stand-offs where N is an integer of 3 or more extending from and evenly spaced at 360/N degree intervals about the top surface; and
a second set of N stand-offs extending from and evenly spaced at 360/N degree intervals about the bottom surface,
wherein first and second sets of stand-offs are angularly offset from each other by 360/2N degrees such that each said stand-off is evenly spaced between adjacent pairs of stand-offs on the opposing surface,
said first and second sets of stand-offs responsive to opposing axial loads to deflect the flat annular beam axially at each stand-off in opposing directions to induce a curvature to the annular beam and store energy in the beam.

2. The annular cantilever beam spring of claim 1, wherein each stand-off comprises one or more protrusions.

3. The annular cantilever beam spring of claim 2, wherein each stand-off comprises a single protrusion,

4. The annular cantilever beam spring of claim 3, wherein N=3, the stand-offs are evenly spaced at 120 degrees around the flat annular beam and the first and second sets are rotated by 60 degrees with respect to each other.

5. The annular cantilever beam spring of claim 1, wherein a radius of the flat annular beam contracts as the curvature is induced in the annular beam.

6. The annular cantilever beam spring of claim 1, wherein the flat annular beam and stand-offs are formed of a material selected from aluminum or titanium.

7. The annular cantilever beam spring of claim 1, wherein the flat annular beam and stand-offs are formed of a material selected from 440C stainless steel, 52100 chrome steel or ceramics.

8. A pre-loaded assembly, comprising:
first and second mating parts positioned along an axis; and
an annular cantilever beam spring positioned about the axis in-line with and internal or external to the first and second mating parts,
a pre-load mechanism configured to apply opposing axial loads to the first and second mating parts and spring to compress the spring and apply a preload within a specified operating range of the assembly,
wherein the annular cantilever beam spring comprises:
a flat annular beam sized to match either the first and second mating parts, said flat annular beam having top and bottom surfaces about the axis;
a first set of N protrusions where N is an integer of 3 or more extending from and evenly spaced at 360/N degree intervals about the top surface of the flat annular beam to engage an axial facing surface of the first mating part; and
a second set of N stand-offs extending from and evenly spaced at 360/N degree intervals about the bottom surface of the flat annular beam to engage an axial facing surface of the second mating part or the pre-load mechanism,
wherein first and second sets of stand-offs are angularly offset from each other by 360/2N degrees such that each said stand-off is evenly spaced between adjacent pairs of stand-offs on the opposing surface,
said first and second sets of stand-offs responsive to the opposing axial loads to deflect the flat annular beam axially at each stand-off in opposing directions to induce a curvature to the annular beam and store energy in the beam to preload the assembly.

9. The pre-loaded assembly of claim 8, wherein each stand-off comprises one or more protrusions.

10. The pre-loaded assembly of claim 9, wherein N=3, the stand-offs are evenly spaced at 120 degrees around the flat annular beam and the first and second sets are rotated by 60 degrees with respect to each other.

11. The pre-loaded assembly of claim 8, wherein a radius of the flat annular beam contracts as the curvature is induced in the annular beam.

12. The annular cantilever beam spring of claim 8, wherein the flat annular beam and stand-offs are formed of a material selected to match the first and second mating parts.

13. The pre-loaded assembly of claim 8, wherein the axial surfaces are flat and engage only the stand-offs to induce curvature to the annular beam.

14. The pre-loaded assembly of claim 8, wherein the assembly is a bearing assembly in which the first mating part is an annular bearing and the pre-load mechanism provides the second mating part.

15. The pre-loaded assembly of claim 8, wherein the assembly is a dual-bearing assembly in which the first and second mating parts are first and second bearings, each bearing including inner and outer races and a plurality of rolling elements between the inner and outer races to allow the races to rotate about the axis relative to each other, wherein the flat annular beam is sized to match either the inner or outer race of each bearing, wherein the opposing axial loads create load paths through the spring and the rolling elements of the first and second bearings.

16. The pre-loaded assembly of claim 8, wherein the assembly is a spring clutch in which the first mating part is a friction plate and the second mating part is a stop, wherein the annular beam spring is pre-loaded to produce a frictional force between a friction disc and an axially-fixed member positioned about a rotating shaft.

17. A method of preloading an assembly, said assembly including first and second mating parts positioned along an axis, said method comprising:
providing an annular cantilever beam spring that includes a flat annular beam, first and second sets of N stand-offs where N is an integer of 3 or more extending from and evenly spaced at 360/N degree intervals top and bottom surfaces of the beam, in which the first and second sets of stand-offs are angularly offset from each other by 360/2N degrees such that each said stand-off is evenly spaced between adjacent pairs of stand-offs on the opposing surface,
placing the spring about the axis and in-line with and internal or external to the first and second mating parts; and
applying opposing axial loads to the assembly and to the first and second sets of stand-offs to deflect the flat annular beam axially at each stand-off in opposing directions to induce a curvature to the annular beam and store energy in the beam to pre-load the assembly.

18. The method of claim 17, wherein N=3, the stand-offs are evenly spaced at 120 degrees around the flat annular beam and the first and second sets are rotated by 60 degrees with respect to each other, wherein each stand-off includes a single protrusion.

19. The method of claim 17, wherein the opposing axial loads are applied through opposing flat axial surfaces that engage only the stand-offs to induce curvature to the annular beam.

20. The method of claim 17, wherein a radius of the flat annular beam contracts as the curvature is induced in the annular beam.
